(19) United States
(12) Patent Application Publication
(10) Pub. No.: US 2023/0407128 A1
(43) Pub. Date: Dec. 21, 2023

(54) UV-CURABLE COATING COMPOSITION COMPRISING AN UNSATURED POLY(ETHYLENE-ACRYLATE) COPOLYMER AND METHOD OF COATING SUBSTRATES

(71) Applicant: BASF COATINGS GMBH, Münster (DE)

(72) Inventors: Shampa R. SAMANTA, Southfield, MI (US); David W BRAUN, Whitehouse, OH (US); Donald H CAMPBELL, Hartland, MI (US)

(21) Appl. No.: 18/250,255

(22) PCT Filed: Oct. 26, 2021
(86) PCT No.: PCT/EP2021/079683

§ 371 Date: Apr. 24, 2023

(30) Foreign Application Priority Data
Nov. 3, 2020 (EP) 20205325.2

(51) Int. Cl. C09D 137/00; C08K 5/5397

(52) U.S. Cl. CPC C09D 137/00; C08K 5/5397

(57) ABSTRACT

Disclosed herein are coating compositions, particularly UV-curable coating compositions, including at least one unsaturated ethylene copolymer as binder and optionally at least one photoinitiator, a method of coating substrates with such coating compositions, and coated substrates obtained by the method. Further disclosed herein is a method of using such coating compositions for improving the flexibility of coating layers, particularly primer layers.

The present invention relates to coating compositions, particularly UV-curable coating compositions, comprising at least one unsaturated ethylene copolymer as binder and optionally at least one photoinitiator, a method of coating substrates with such coating compositions and coated substrates obtained by said method. Moreover, the present invention relates to the use of such coating compositions for improving the flexibility of coating layers, particularly primer layers.

### STATE OF THE ART

It is already known to use coating compounds curable by high-energy radiation in automotive coating. Multilayer paint coatings using UV curing processes offer many advantages over typical heat curable compositions.

Heat curable compositions require the use of organic solvents that contain a significant amount of volatile organic compounds (VOCs). These VOCs escape into the atmosphere while the heat curable composition dries. Such solvent based systems are undesirable because of the hazards and expense associated with VOCs. The hazards include water and air pollution and the expenses include the cost of complying with strict government regulation on solvent emission levels. In contrast, UV curable compositions enable using solvent-free, reactive monomers and oligomers, which can result in significant reduction of and even elimination of organic solvents, thus reducing the detrimental effects of the VOCs.

Additionally, the process of heat curing typically requires large amounts of energy. In the typical heat curing process, the base coat must be inordinately thick in order to hide the primer coat. Additionally, the thick base coat must be dried for a significant time to eliminate intermixing between the base coat and topcoat. Thus, these processes are rather uneconomic due to the large energy consumption necessary to achieve drying and curing of the applied heat curable coating compositions.

Although UV curable compositions exhibit superior properties and performance over their heat curable counterparts, UV curable compositions themselves suffer from certain disadvantages. Generally, UV curable compositions have high molecular weights and a substantial degree of cross linkage due to the highly reactive nature of the composition. As a result, many of these compositions suffer from low durability and resin shrinkage, which results in stresses and cracks in the film and might lead to detachment of the coating from the underlying surface.

Therefore, UV-curable coatings with a high flexibility and a high mechanical strength, especially hardness, are required to provide automotive coatings having good appearance as well as a high durability. The mechanical properties of UV-cured coating layers strongly depend on the effective chain length between the crosslinks as well as the glass transition temperature of the cured coating layer. Lower crosslinking densities, i.e. high effective chain length, generally lead to more flexible films. However, commonly used acrylic copolymers comprising free acryloyl moieties used in UV-curable coating compositions fail to provide adequate flexibility due to their low effective chain length at a given crosslinking density. This low effective chain length is resulting from long side chains being present in said acrylic copolymers.

Currently, UV-curable hyperbranched or multi-arm urethane acrylate copolymers are widely used as flexible raw materials in UV-curable coating compositions. However, these urethane acrylate copolymers are obtained using hazardous isocyanate precursors, are expensive and are not produced from bio renewable sources.

Despite recent improvements in the flexibility and mechanic strength of UV-curable coating systems, there remains a need in the automotive coatings art for UV-curable coating compositions containing binders which can be prepared without the use of hazardous isocyanates or isocyanate precursors from bio renewable sources. Moreover, it would be advantageous to provide UV-cured coating layers for substrates utilized in the automotive industry which are both flexible and have a high mechanical strength.

### OBJECT

Accordingly, the object of the present invention is to provide a UV curable coating composition suitable as primer composition in OEM finishes and automotive refinishes, which results in coating layers having a high flexibility as well as a high mechanical strength, preferably hardness. In addition, the coating compositions should contain binders which are prepared from bio renewable materials without the use of isocyanate containing compounds. Furthermore, the coating compositions ought to have a high storage stability as well as fast curing times.

### TECHNICAL SOLUTION

The objects described above are achieved by the subject matter claimed in the claims and also by the preferred embodiments of that subject matter that are described in the description hereinafter.

A first subject of the present invention is therefore a coating composition comprising:
a) at least one binder B, said binder B being prepared by reacting
   a1) at least one ethylene copolymer comprising—in polymerized form—
      i. 10 to 80 wt. % of ethylene;
      ii. 1 to 80 wt. % of at least one polymerizable compound C1 having at least one epoxide group; and
      iii. 0 to 80 wt. % of at least one further polymerizable compound C2 being different from compound C1; with
   a2) at least one compound C3 having at least one unsaturated group and at least one functional group which is able to react with the at least one epoxide group of compound C1; and
b) optionally at least one photoinitiator.

The above-specified coating composition is hereinafter also referred to as coating composition of the invention and accordingly is a subject of the present invention.

Preferred embodiments of the coating composition of the invention are apparent from the description hereinafter and also from the dependent claims.

In light of the prior art it was surprising and unforeseeable for the skilled worker that the object on which the invention is based could be achieved by using an unsaturated ethylene copolymer as binder. The use of the unsaturated ethylene copolymer results in coating compositions which provide coating layers having an improved flexibility without negatively influencing the mechanical strength, especially hardness, as compared to coating layers being prepared from coating compositions comprising unsaturated acrylic resins. Additionally, the unsaturated ethylene copolymer can be prepared using the bio renewable material ethylene in the absence of isocyanate compounds. Thus, the binders used in the inventive coating compositions have a better viability and are therefore more sustainable than isocyanate containing binders commonly used in UV-curable coating compositions. Moreover, the inventive coating compositions can be easily prepared, show a high storage stability and fast curing times.

A further subject of the present invention is a method for producing at least one coating on a substrate, comprising
(1) applying at least one inventive coating composition to the substrate;
(2) forming a coating film from the composition applied in step (1);
(3) curing the coating film obtained after step (2); and
(4) optionally applying at least one further pigmented or unpigmented coating composition being different from the coating composition applied in step (1) to the cured coating film obtained after step (3), forming a film from said at least one further coating composition and curing said at least one further coating composition.

Another subject of the present invention is a coating obtained by the inventive method.

A final subject of the present invention is the use of an inventive coating composition for improving the flexibility of coating layers, especially of primer layers or primer-surfacer layers.

### DETAILED DESCRIPTION

The measurement methods to be employed in the context of the present invention for determining certain characteristic variables can be found in the Examples section. Unless explicitly indicated otherwise, these measurement methods are to be employed for determining the respective characteristic variable. Where reference is made in the context of the present invention to an official standard without any indication of the official period of validity, the reference is implicitly to that version of the standard that is valid on the filing date, or, in the absence of any valid version at that point in time, to the last valid version.

The term “ethylene copolymer” refers to polymers derived from ethylene and at least one further monomer which can be polymerized with ethylene under suitable reaction conditions. Preferably, said at least one further monomer therefore contains at least one unsaturated moiety. Consequently, the term “polymerizable compound” in connection with compounds C1 and C2 refers to a compound, preferably a monomer, which can be polymerized with ethylene under suitable reaction conditions. Preferably, said compounds C1 and C2 therefore each contain at least one unsaturated moiety.

The term “(meth)acrylate” refers both to acrylates and to methacrylates. (Meth)acrylates may therefore be composed of acrylates and/or methacrylates and may comprise further ethylenically unsaturated monomers such as styrene or acrylic acid, for example.

All film thicknesses reported in the context of the present invention should be understood as dry film thicknesses. It is therefore the thickness of the cured film in each case. Hence, where it is reported that a coating material is applied at a particular film thickness, this means that the coating material is applied in such a way as to result in the stated film thickness after curing.

All temperatures elucidated in the context of the present invention should be understood as the temperature of the room in which the substrate or the coated substrate is located. It does not mean, therefore, that the substrate itself is required to have the temperature in question.

### Inventive Coating Composition

### Binder B:

The inventive coating composition comprises as first mandatory component (a) at least one binder B, comprising at least one unsaturated moiety. Said binder B is prepared by reacting
a1) at least one ethylene copolymer, preferably exactly one ethylene copolymer, comprising—in polymerized form—
   i. 10 to 80 wt. % of ethylene;
   ii. 1 to 80 wt. % of at least one polymerizable compound C1 having at least one epoxide group; and
   iii. 0 to 80 wt. % of at least one further polymerizable compound C2 being different from compound C1; with
a2) at least one compound C3 having at least one unsaturated group and at least one functional group which is able to react with the at least one epoxide group of compound C1.

Where it is stated in the context of the present invention that the ethylene copolymer comprises components i., ii. and optionally iii. in polymerized form, this means that these particular components are used as starting compounds for the preparation of the ethylene copolymer in question. Since ethylene can be polymerized with further monomers comprising unsaturated moieties, the ethylene copolymer preferably comprises the unsaturated moieties, previously present in ethylene and the further monomer(s), in the form of C—C single bonds, in other words in their correspondingly reacted form. Accordingly, for the sake of clarity, it is stated that the respective copolymer comprises the components, in each case in polymerized form. The meaning of the expression “the ethylene copolymer comprises, in polymerized form, a component (X)” can therefore be equated with the meaning of the expression “component (X) was used in the course of the preparation of the ethylene copolymer as a monomeric compound”.

The ethylene copolymer al) is preferably prepared in a semi-continuous high-pressure polymerization process or a continuous high-pressure polymerization process, preferably a continuous high-pressure polymerization process. The term “high-pressure continuous polymerization process” refers, in the context of this invention”, to a polymerization process comprising a continuous feed of the starting materials i., ii., optionally iii. and optionally at least one chain transfer agent and/or solvent listed below (also called monomer feed hereinafter) and a continuous output of the produced ethylene copolymer at a pressure of 1,000 to 4,000 bar. The term “semi-continuous high-pressure polymerization process” in turn refers, in the context of this invention”, to a polymerization process comprising a semi-continuous feed of the starting materials i., ii., optionally iii. and optionally at least one chain transfer agent and/or solvent listed below (also called monomer feed hereinafter) and a semi-continuous output of the produced ethylene copolymer at a pressure of 1,000 to 4,000 bar. The polymerization process may continue for at least 3 h, preferably at least 24 h, and in particular at least 72 h.

The polymerization process may be carried out in stirred high-pressure autoclaves, hereinafter also referred to as high-pressure autoclaves, or in high-pressure tube reactors, hereinafter also referred to as tube reactors. Preference is given to the high-pressure autoclaves, which may have a length/diameter ratio in the range from 5:1 to preferably from 10:1 to 20:1.

The polymerization process may be carried out at a pressure in the range from 1,000 to 4,000 bar, preferably from 1,200 to 2,500 bar, and particularly 1,500 to 2,200 bar. It is possible to change the pressure during the polymerization either gradually or suddenly. In case the pressure is changed, however, the pressure is still kept within the afore-stated ranges.

The polymerization process may be carried out at a reaction temperature in the range of 150 to 300° C., preferably 170 to 250° C., and in particular 190 to 230° C.

The monomer feed comprises the ethylene, the at least one polymerizable compound C1 and optionally the at least one polymerizable compound C2. The ethylene, compound C1, optionally compound C2 and further compounds and solvents listed below can be mixed before, during, or after entering the high-pressure autoclaves or the high-pressure tube reactors. Preferably, ethylene, compound C1, optionally compound C2 and the chain transfer agent listed below are mixed before entering the high-pressure autoclaves. Typically, the polymerization process takes place in the polymerization zone, which is usually inside the high-pressure autoclave or the high-pressure tube reactor. Mixing of the aforestated compounds and solvents before entering the high-pressure autoclave or reactor can be performed in the middle zone pressure of 200 to 300 bar and is called mixing within the compressor. Mixing within the compressor results in an increased homogeneity of the obtained mixture. Alternatively, all liquid compounds (i.e. compressed liquid ethylene, compound C1 and optionally C2, chain transfer agent and solvents) can be directly added to the high-pressure zone of 1,000 to 4,000 bar (called mixing outside of the compressor). In addition, both ways to add the liquid components can be used simultaneously.

Preferably, the monomer feed is free of an initiator, preferably free of an initiator suitable for radical polymerization as listed below.

The monomer feed comprises the ethylene, compound C1 and optionally C2 in amounts which are suitable to arrive at the amounts previously listed in connection with the ethylene copolymer a1).

Usually, the monomer feed comprises at least 15 wt. %, preferably at least 20 wt. %, and in particular at least 30 wt. % of ethylene, based in each case on the total weight of the monomer feed. In another form, the monomer feed comprises 30 to 98 wt. %, preferably 40 to 95 wt. %, and in particular 50 to 70 wt. % or from 70 to 85 wt. % of ethylene, based in each case on the total weight of the monomer feed.

Usually, the monomer feed comprises at least 1 wt. %, preferably at least 3 wt. %, and in particular at least 10 wt. % of polymerizable compound C1 comprising at least one epoxy group, where the percentage is based in each case on the total weight of the monomer feed. In another form, the monomer feed comprises 1 to 45 wt. %, preferably 3 to 35 wt. % of polymerizable compound C1 comprising at least one epoxy group.

The monomer feed may comprise 0 to 10% wt., preferably 0 to 20% wt., more preferably 0 to 30% wt., very preferably 0 to 40% wt., of polymerizable compound C2, where the percentage is based in each case on the total weight of the monomer feed.

The conversion of the ethylene is usually around 15 to 70 wt. %, preferably 25 to 55 wt. % and in particular 30 to 45 wt. %, based in each case on the ethylene feed. The input (e.g. kg monomer feed per hour) and the output (e.g. kg ethylene copolymer a1) per hour) of the polymerization process depend on the size of the equipment. For example, a 1 liter autoclave may allow an input of 6 to 25 kg/h monomer feed, or an output of 3 to 8 kg/h ethylene copolymer.

The polymerization of the monomer feed comprising ethylene, compound C1 and optionally C2 is usually carried out in the presence of at least one chain transfer agent. Suitable chain transfer agents in the sense of this invention are compounds which are terminate the polymerization reaction by being incorporated as terminus of the copolymer chain. Suitable chain transfer agents are selected from saturated or unsaturated hydrocarbons, aliphatic ketones, aliphatic aldehydes, hydrogen, or mixtures thereof. The term “aliphatic” as used herein includes the term “cycloaliphatic” and refers to non-aromatic groups, moieties and compounds, respectively.

Among saturated and unsaturated hydrocarbons the chain transfer agents can be selected from pentane, hexane, cyclohexane, isododecane, propene, butene, pentene, cyclohexene, hexene, octene, decen and dodecen, and from aromatic hydrocarbons such as toluene, xylol, trimethyl-benzene, ethylbenzene, diethylbenzene, triethylbenzene, mixtures thereof.

Suitable ketones or aldehydes as chain transfer agents are aliphatic aldehydes or aliphatic ketones, such as compounds of general formula (I)

R¹—C(O)—R² (I)

wherein

R¹ and R² are, independently from each other selected from
hydrogen;
C₁-C₆-alkyl groups, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl and sec-hexyl groups, more preferably C₁-C₄-alkyl groups such as methyl, ethyl, n-propyl, isopropyl, n-butyl, isobutyl, sec-butyl and tert-butyl groups; or
C₃-C₁₂-cycloalkyl groups such as cyclopropyl, cyclobutyl, cyclopentyl, cyclohexyl, cycloheptyl, cyclooctyl, cyclononyl, cyclodecyl, cycloundecyl and cyclododecyl groups, more preferably cyclopentyl, cyclohexyl and cycloheptyl groups.

The R¹ and R² residues may also be covalently bonded to one another to form a 4- to 13-membered ring. For example, R¹ and R² may form the following alkylene groups: —(CH₂)₄—, —(CH₂)₅—, —(CH₂)₆—, —(CH₂)₇—, —CH(CH₃)—CH₂—CH₂—CH(CH₃)— or —CH(CH₃)—CH₂—CH₂—CH₂—CH(CH₃)—.

Preferred ketones as chain transfer agents are acetone, methylethylketone, diethylketone and diamylketone. Preferred aldehydes as chain transfer agents are acetaldehyde, propionaldehyde, butanal and pentanal.

Among alcohols the chain transfer agents are selected from the group consisting of methanol, ethanol, propanol, isopropanol, butanol and pentanol.

Among thiols the chain transfer agents maybe selected from mercaptoethanol to tetradecanthiol. In another form suitable thiols are organic thio compounds, such as primary, secondary, or tertiary aliphatic thiols, such as, ethanethiol, n-propanethiol, 2-propanethiol, n-butanethiol, tert-butanethiol, 2-butanethiol, 2-methyl-2-propanethiol, n-pentanethiol, 2-pentanethiol, 3-pentanethiol, 2-methyl-2-butanethiol, 3-methyl-2-butanethiol, n-hexanethiol, 2-hexanethiol, 3-hexanethiol, 2-methyl-2-pentanethiol, 3-methyl-2-pentanethiol, 4-methyl-2-pentanethiol, 2-methyl-3-pentanethiol, 3-methyl-3-pentanethiol, 2-ethylbutanethiol, 2-ethyl-2-butanethiol, n-heptanethiol and its isomeric compounds, n-octanethiol and its isomeric compounds, n-nonanethiol and its isomeric compounds, n-decanethiol and its isomeric compounds, n-undecanethiol and its isomeric compounds, n-dodecanethiol and its isomeric compounds, n-tridecanethiol and its isomeric compounds, substituted thiols, such as 2-hydroxyethanethiol, aromatic thiols, such as benzenethiol, ortho-, meta-, or para-methyl-benzenethiol, mercaptoalkanoic acid and derivatives thereof, such as 6-methylheptyl 3-mer-captopropionate or 2-ethylhexyl 2-mercaptoethanoate.

Among amines the chain transfer agents are selected from primary, secondary, or tertiary amines, such as dialkyl amines or trialkyl amines. Examples for amines are propyl amine, dipropyl amine, dibutyl amine, triethyl amine.

Preferred chain transfer agents are aliphatic aldehydes and/or aliphatic ketones and/or hydrogen. Particularly preferred chain transfer agents are propionaldehyde and/or methylethylketone and/or hydrogen.

The weight ratio of propionaldehyde to methylethylketone may be in the range from 4:1 to 1:4, preferably from 3.5:1 to 1:3.0, in particular from 2.8:1 to 1:2.5

The monomer feed comprising the ethylene, compound C1 and optionally C2 may be polymerized in the presence of at least 2 wt. % of chain transfer agent, based on the total weight of the monomer feed and the chain transfer agent. The chain transfer agent may be used in amounts of 4 to 28 wt. %, preferably 6 to 23 wt. %, and in particular 9 to 13 wt. % or 13 to 20 wt. %, based in each case on the total weight of the monomer feed and chain transfer agent.

The chain transfer agents can be diluted with suitable solvents (e.g. hydrocarbons), preferably they are used without additional solvents.

The polymerization process is usually a free-radical polymerization and thus initiated by an initiator. Suitable initiators are organic peroxides, oxygen or azo compounds. Mixtures of a plurality of free-radical initiators are also suitable.

Suitable peroxides are didecanoyl peroxide, 2,5-dimethyl-2,5-di(2-ethylhexanoylperoxy)hexane, tert-amyl peroxypivalate, tert-amyl peroxy-2-ethylhexanoate, dibenzoyl peroxide, tert-butyl peroxy-2-ethylhexanoate, tert-butyl peroxydiethylacetate, tert-butyl peroxydiethylisobutyrate, 1,4-di(tert-butylperoxycarbonyl)cyclohexane as isomer mixture, tert-butyl perisononanoate, 1,1-di(tert-butylperoxy)-3,3,5-trimethylcyclohexane, 1,1-di(tert-butylperoxy)cyclo-hexane, methyl isobutyl ketone peroxide, tert-butyl peroxyisopropylcarbonate, 2,2-di(tert-butylperoxy)butane or tert-butyl peroxacetate; tert-butyl peroxybenzoate, di-tert-amyl peroxide, dicumyl peroxide, the isomeric di-(tert-butylperoxyisopropyl)benzenes, 2,5-dimethyl-2,5-di-tert-butylperoxyhexane, tert-butyl cumyl peroxide, 2,5-dimethyl-2,5-di(tert-butylperoxy)hex-3-yne, di-tert-butylperoxide, 1,3-diisopropylbenzene monohydroperoxide, cumene hydroperoxide or tert-butyl hydroperoxide, or dimeric or trimeric ketone peroxides.

As azo compound azodicarboxylic esters, azodicarboxylic dinitriles are suitable, mention may be made by way of example of azobisisobutyronitrile (“AIBN”).

Preferred initiators are selected from the group consisting of di-tert-butyl peroxide, tert-amyl peroxypivalate, tert-butyl peroxypivalat, tert-butyl peroxyisononanoate, tert-butyl peroxy-2-ethylhexanoate, 2,2-di(tert-butylperoxy)butane and mixtures thereof. Preferably tert-amyl peroxypivalate is used as initiator.

Initiators, e.g. organic peroxides, are often mixed with solvents to make them easier to handle. In a preferred form the initiator is introduced in the form of a solution in one or more ketone(s) or hydrocarbons (especially olefins) which are liquid at room temperature. The initiator is preferably fed in as a 0.1 to 50% strength by weight solution, preferably a 0.5 to 20% strength by weight solution, in one or more hydrocarbons or one or more ketone(s) which are liquid at room temperature, mixtures of hydrocarbons (e.g. olefins or aromatic hydrocarbons such as toluene, ethylbenzene, ortho-xylene, meta-xylene and para-xylene, also cycloaliphatic hydrocarbons such as cyclohexane and aliphatic C₆-C₁₆-hydrocarbons, either branched or unbranched, for example n-heptane, n-octane, isooctane, n-decane, n-dodecane and in particular isododecane) or ketones (e.g. acetone, methyl isobutyl ketone, ethyl methyl ketone). In cases where the solvents for the initiator also function as chain transfer agents (for example ketones), the amount of said solvent is taken into account when calculating the amount of the chain transfer agent in the monomer feed.

The amount of the initiator depends on the chemical nature of the initiator and can by adjusted by routine experiments. Typically, the initiator is present in 0.001 to 0.1 wt. %, preferably 0.01 to 0.05 wt. % based in each case on the total weight of the monomer feed.

The initiators employed herein can be introduced into the polymerization zone in any suitable manner, for example, by dissolving the initiator in a suitable solvent and injecting the initiator solution directly into the polymerization zone. Alternatively, the initiator may be injected into the ethylene feed stream or the feed stream containing compound C1 and optionally C2, prior to introduction thereof into the polymerization zone. The initiator can, for example, be fed in at the beginning, in the middle or after one third of the tube reactor. Initiator can also be fed in at a plurality of points on the tube reactor. The initiator can either be fed in at one point in the middle of the autoclave or in the upper part and the middle or bottom of the autoclave. In addition three or more injections are possible.

In a preferred form of the polymerization process the monomer feed containing ethylene, compound C1 and optionally compound C2 is passed in the presence of the chain transfer agent at a temperature within the range from about 20 to 50° C., for example 25 of 30° C., preferably continuously, into a stirred autoclave which is maintained at a pressure in the range from about 1,200 to 2,500 bar. The preferably continuous addition of the initiator, which is generally dissolved in a suitable solvent, for example isododecane or methylethylketone, keeps the temperature in the reactor at the desired reaction temperature, for example at 150 to 280° C. The polymer obtained after the decompression of the reaction mixture may be then isolated. Modifications to this method are of course possible and can be undertaken by those skilled in the art without unreasonable effort. For example, the monomers and the chain transfer agent can also be separately added into the reaction mixture using suitable pumps, or the reaction temperature can be varied during the process.

The polymerization process may be followed by post polymerization reactions, such as a hydrogenation. The hydrogenation may be a homogeneous or heterogenous catalytic hydrogenation. Usually, the hydrogenation is achieved with molecular hydrogen in the presence of a transition metal catalyst (e.g. based on Rh, Co, Ni, Pd, or Pt), which may be dissolved in solvents or supported on inorganic supports.

The ethylene copolymer is usually not crystalline, so that in general no crystallization commencement temperature (Tcc) is measurable at T>15° C. with differential scanning calorimetry. Usually, a melt flow index cannot be determined for the ethylene copolymer.

The ethylene copolymer a1) preferably has a weight per epoxy—based on the solids of the ethylene copolymer a1)—of 50 to 500 g/mol, more preferably 100 to 400 g/mol, even more preferably 150 to 350 g/mol, very preferably 250 to 300 g/mol, as determined by titration with in-situ generated hydrogen bromide (HBr) according to ASTM D1652-11 (2019).The weight per epoxy corresponds to g/mol of epoxy or epoxy equivalent weight of the ethylene copolymer a1).

The ethylene copolymer may have a pour point below 25° C., preferably below 20° C., more preferably below 15° C., very preferably below 0° C., as determined according to ASTM D 97-05. Due to this low pour point, the ethylene copolymer is liquid at room temperature, thus allowing an easy incorporation of said ethylene copolymer as binder in coating compositions preferably having a viscosity of less than 1,000 m Pa*s at 25° C. (determined according to ASTM D2196-18), i.e. being liquid at 25° C.

The ethylene copolymer may be a clear liquid at room temperature, e.g. at 25° C. Typically, in a clear liquid no turbidity is visible.

The ethylene copolymer may have a viscosity index of at least 100, preferably at least 120, and in particular of at least 180. The viscosity index may be determined according to ASTM D2270-04.

The ethylene copolymer preferably has a weight-average molecular weight M_{w} from 1,000 to 30,000 g/mol, more preferably from 1,500 to 20,000 g/mol, very preferably 3,000 to 12,000 g/mol, as determined by gel-permeation chromatography using polystyrene standards. The number-average molecular weight Mₙ of the ethylene copolymer is preferably in the range from 1,000 to 15,000 g/mol, preferably from 1,200 to 9,000 g/mol, more preferably from 1,500 to 6000 g/mol, very preferably from 1,700 to 5,000 g/mol. The Mₙ can be determined as previously described in connection with the M_{w}.

The ethylene copolymer usually has a polydispersity PD (M_{w}/Mₙ) of 1.3 to 5, preferably 1.5 to 3, more preferably 1.8 to 2.6.

The ethylene copolymer preferably has a kinematic viscosity at 120° C. (V120) of 10 to 5,000 mm²/s (cst), preferably 40 to 1,500 mm²/g (cst), very preferably 80 to 500 mm²/g (cst), as determined according to ASTM D 445-2018.

The ethylene copolymer a1) may comprise—in polymerized form—from 20 to 80 wt. %, preferably from 25 to 75 wt. %, very preferably from 30 to 70 wt. % of from 30 to 50 wt. %, of ethylene, as determined by ¹H-NMR.

Suitable polymerizable compounds C1 comprising at least one epoxide group are selected from glycidyl acrylate and/or glycidyl methacrylate.

The ethylene copolymer a1) may comprise—in polymerized form—from 11 to 70 wt. %, preferably from 13 to 65 wt. %, very preferably from 15 to 60 wt. %, of at least one polymerizable compound C1 comprising at least one epoxide group, preferably glycidyl acrylate and/or glycidyl methacrylate, as determined by ¹H-NMR.

Polymerizable compounds C2 can be selected from alkyl (meth)acrylates, hydroxyl group-containing (meth)acrylates and mixtures thereof.

In this regard, suitable alkyl (meth)acrylates are selected from C₁-C₂₂ alkyl (meth)acrylates, more preferably from C₁-C₁₂ alkyl (meth)acrylates such as C₃ alkyl (meth)acrylates, C₄ alkyl (meth)acrylates, C₅ alkyl (meth)acrylates, C₆ alkyl (meth)acrylates, C₇ alkyl (meth)acrylates and C₈ alkyl (meth)acrylates, very preferably from methyl (meth)acrylate and/or n-butyl (meth)acrylate and/or 2-ethylhexyl (meth)acrylate.

Suitable hydroxyl group-containing (meth)acrylates are selected from hydroxy C₁-C₁₂ alkyl group-containing (meth)acrylates, more preferably selected from 2-hydroxyethyl (meth)acrylate, 2-hydroxyisopropyl (meth)acrylate, 3-hydroxypropyl (meth)acrylate and 4-hydroxybutyl (meth)acrylate, preferably 2-hydroxyethyl (meth)acrylate.

The ethylene copolymer a1) may comprise—in polymerized form—from 5 to 70 wt. %, preferably from 10 to 65 wt. %, very preferably from 15 to 60 wt. %, of at least one polymerizable compound C2, preferably methyl (meth)acrylate and/or n-butyl (meth)acrylate and/or 2-ethylhexyl (meth)acrylate and/or 2-hyroxyethyl (meth)acrylate, as determined by ¹H-NMR.

Preferably, the functional group of the at least one compound C3 is selected from hydroxy groups, carboxylic acid groups, thiol groups, primary amino groups, secondary amino groups and mixtures thereof, preferably carboxylic acid groups.

Suitable unsaturated groups of the at least one compound C3 are selected from acryloyl and/or allyl groups, preferably acryloyl groups.

With particular preference, the at least one compound C3 is selected from acrylic acid and/or methacrylic acid and/or allyl mercaptan, very preferably acrylic acid.

The at least one compound C3 is preferably reacted with the ethylene copolymer a1) in a total amount of 1 to 50 wt. % by weight, more preferably 5 to 30 wt. % by weight, even more preferably 10 to 25 wt. % by weight , based on the total solid of binder B.

Preferably, the at least one compound C3 is reacted with the ethylene copolymer al) in butyl acetate. Use of butyl acetate as solvent renders is possible to include the resulting binder B directly into solvent-based coating compositions without a negative influence of this solvent on the performance of cured coating layers obtained from said composition. Moreover, the ethylene copolymer al), the compound C3 as well as the produced binder B are readily soluble in said solvent, thus minimizing the formation of undesired precipitation or undissolved starting material.

In order to ensure complete and fast reaction of the compound C3 with the ethylene copolymer a1), said reaction is preferably catalyzed by at least one catalyst. Suitable catalysts are all catalysts known in the state of the art to catalyze the reaction between an epoxide and an carboxylic acid group, for example amine compounds, phosphorous compounds, metal salts and mixtures thereof. With particular preference, tertiary amines having at least one C₆₋₂₀ alkyl group, more preferably at least one C₁₁₋₁₃ alkyl group are used as catalyst. Very favorably, dimethyl dodecyl amine is used as catalyst.

The at least one binder B preferably has a weight-average molecular weight Mw from 1,000 to 30,000 g/mol, more preferably from 1,500 to 15,000 g/mol, very preferably 3,000 to 5,000 g/mol, as determined by gel-permeation chromatography using polystyrene standards.

Suitable binders B have an average double-bond functionality of 1 to 15, preferably 2 to 10, very preferably 2.5 to 7, as determined by titration with in-situ generated hydrogen bromide (HBr) according to ASTM D1652-11 (2019). The double-bond functionality can be calculated by determination of how much epoxy functionality of the ethylene copolymer a1) was consumed during the reaction with compound C3, i.e. by comparison of the epoxy functionality of the ethylene copolymer a1) and the polymer obtained after reaction of the ethylene copolymer a1) with the at least one compound C3. The epoxy functionality can be determined by titration with hydrogen bromide (HBr) as previously described. The afore-mentioned average double-bond functionality ensures that a sufficient crosslinking is achieved upon curing of the inventive coating composition.

Preferably, the coating composition comprises the at least one binder B in a total amount of 10 to 60 wt. %, more preferably 15 to 50 wt. %, even more preferably 25 to 45 wt. %, very preferably 30 to 40 wt. %, based in each case on the total weight of the coating composition. Use of the binder B in the stated amounts results in sufficient crosslinking upon curing of the inventive coating composition. In case more than one binder B is used, these amounts refer to the total amount of all binders B present in the inventive coating composition.

### Photoinitiator:

The inventive coating composition may further comprise at least one photoinitiator. This is preferred, if curing of the inventive coating composition is performed by UV radiation.

Suitable photoinitiators are selected from the group consisting of phosphine oxides, benzophenones, α-hydroxyalkyl aryl ketones, thioxanthones, anthraquinones, acetophenones, benzoins and benzoin ethers, ketals, imidazoles or phenylglyoxylic acids and mixtures thereof. Particularly preferred photoinitiators are diphenyl(2,4,6-trimethylbenzoyl)phosphine oxide, ethyl (2,4,6-trimethylbenzoyl)phenylphosphinate, phenylbis(2,4,6-trimethylbenzoyl)phosphine oxide, benzophenone, 1-benzoylcyclohexan-1-ol, 2-hydroxy-2,2-dimethylacetophenone and 2,2-dimethoxy-2-phenylacetophenone and mixtures thereof, preferably a mixture of ethyl phenyl(2,4,6-trimethylbenzoyl)phosphinate and phenyl bis(2,4,6-trimethylbenzoyl)phosphine oxide. Use of a mixture of ethyl phenyl(2,4,6-trimethylbenzoyl)phosphinate and phenyl bis(2,4,6-trimethylbenzoyl)phosphine oxide results in a high double-bond conversion of the binder B upon irradiation and thus in a sufficient curing of the inventive coating composition within fast curing times.

The at least one photoinitiator is preferably present in a total amount of 0.1 to 10 wt. %, more preferably 0.5 to 8 wt. %, very preferably 1 to 5 wt. %, based on the total weight of the coating composition.

Reactive diluent:

The inventive coating composition may further comprise at least one reactive diluent. Said reactive diluent can be used to tune the elongation at break and hardness of the cured coating film without negatively influencing the flexibility of said coating film. For example, the elongation at break can be increased while the hardness is decreased when a reactive diluent is present in the inventive coating composition. The term reactive diluent refers to low weight monomers which are able to participate in a polymerization reaction to form a polymeric material. The weight average molecular weight M_{w} of such monomer compounds preferably is less than 1000 g/mol and more preferably less than 750 g/mol, as determined by GPC.

Preferably, the reactive diluents are free-radically polymerizable monomers and include, for example, ethylenically-unsaturated monomers such as (meth)acrylates, styrene, vinyl acetate and mixtures thereof. Preferred monomers include (meth)acryloyl-functional monomers such as, for example, alkyl (meth)acrylates, aryloxyalkyl (meth)acrylates, hydroxyalkyl (meth)acrylates, N-vinyl compounds and combinations thereof. Suitable reactive diluents having at least two unsaturated groups are known to the person skilled in the art and can be used to increase the crosslinking density. Especially preferred reactive diluents are selected from the group consisting of alkyl (meth)acrylates, preferably C₁-C₁₂ alkyl (meth)acrylates, very preferably iso-bornyl acrylate.

According to a first preferred embodiment, the at least one reactive diluent is preferably present in a total amount of up to 40 wt. %, very preferably 5 to 25 wt. %, based on the total weight of the coating composition. This is especially preferred if the cured film resulting from the inventive coating composition should have a high elongation at break.

According to an alternative preferred embodiment, the inventive coating composition is free of any reactive diluent, i.e. it does contain less than 1 wt. %, preferably 0 wt. %, based on the total weight of the coating composition, of reactive diluents. This is especially preferred, if the cured coating film obtained from the inventive coating composition are required to possess a high hardness.

Further components of the inventive coating composition:

The inventive coating composition can comprise at least one further binder B1, said binder being different from binder B. The term “binder” in the sense of the present invention and in agreement with DIN EN ISO 4618 (German version, date: March 2007), refers preferably to those nonvolatile fractions of the composition of the invention that are responsible for forming the film, with the exception of any pigments and fillers therein, and more particularly refers to the polymeric resins which are responsible for film formation.

Suitable binders comprise physically and/or thermally and/or chemically curable binders commonly known to the person skilled in the art. In the context of the present invention, “physically curable” or the term “physical curing” means the formation of a cured coating film through evaporation of solvent from polymer solutions or polymer dispersions, the curing being achieved through interlooping of polymer chains. The term “thermally and chemically curable” means the crosslinking of a paint film (formation of a cured coating film) by chemical reaction of reactive functional groups initiated through thermal energy. This can involve reaction of complementary functional groups and/or the reaction of autoreactive groups, i.e. functional groups which inter-react with groups of the same kind. Examples of suitable complementary reactive functional groups and autoreactive functional groups are known, for example, from German patent application DE 199 30 665 A1, page 7 line 28 to page 9 line 24. Chemical curing also includes curing by radiation using, for example, binders comprising unsaturated bonds optionally in combination with at least one photoinitiator.

The crosslinking may be self-crosslinking and/or external crosslinking. If, for example, the complementary reactive functional groups are already present in an organic polymer used as a binder, for example a polyester, a polyurethane or a poly(meth)acrylate, self-crosslinking is present. External crosslinking is present, for example, when a (first) organic polymer containing particular functional groups, for example hydroxyl groups, reacts with a crosslinking agent known per se, for example a polyisocyanate and/or a melamine resin. The crosslinking agent thus contains reactive functional groups complementary to the reactive functional groups present in the (first) organic polymer used as the binder.

Preferred further binders B1 are selected from hydroxy-functional polymers, such as polyesters, polyethers, poly(meth)acrylates, polyurethanes, polyurethane poly(meth)acrylate copolymers, polyurethane polyurea copolymers, mixtures thereof and copolymers of the stated polymers. A copolymer in the context of the present invention refers to polymer particles formed from different polymers. This explicitly includes both polymers bonded covalently to one another and those in which the different polymers are bound to one another by adhesion. Combinations of the two types of bonding are also covered by this definition. According to a preferred embodiment of the present invention, the coating composition is free of further binders apart from binder B, i.e. the amount of further binders B1 being different from binder B is 0 wt. %, based on the total weight of the coating composition.

The inventive coating compositions can comprise at least one color and/or effect pigment and/or filler commonly used in coating compositions to achieve a specific color. Such color pigments and effect pigments are known to those skilled in the art and are described, for example, in ROmpp-Lexikon Lacke and Druckfarben, Georg Thieme Verlag, Stuttgart, New York, 1998, pages 176 and 451. The terms “coloring pigment” and “color pigment” are interchangeable, just like the terms “visual effect pigment” and “effect pigment”. Suitable inorganic coloring pigments are selected from (i) white pigments, such as titanium dioxide, zinc white, colored zinc oxide, zinc sulfide, lithopone; (ii) black pigments, such as iron oxide black, iron manganese black, spinel black, carbon black; (iii) color pigments, such as ultramarine green, ultramarine blue, manganese blue, ultramarine violet, manganese violet, iron oxide red, molybdate red, ultramarine red, iron oxide brown, mixed brown, spinel and corundum phases, iron oxide yellow, bismuth vanadate; (iv) filer pigments, such as silicon dioxide, quartz flour, aluminum oxide, aluminum hydroxide, natural mica, natural and precipitated chalk, barium sulphate and (vi) mixtures thereof.

Suitable organic coloring pigments are selected from (i) monoazo pigments such as C.I. Pigment Brown 25, C.I. Pigment Orange 5, 36 and 67, C.I. Pigment Orange 5, 36 and 67, C.I. Pigment Red 3, 48:2, 48:3, 48:4, 52:2, 63, 112 and 170 and C.I. Pigment Yellow 3, 74, 151 and 183; (ii) diazo pigments such as C.I. Pigment Red 144, 166, 214 and 242, C.I. Pigment Red 144, 166, 214 and 242 and C.I. Pigment Yellow 83; (iii) anthraquinone pigments such as C.I. Pigment Yellow 147 and 177 and C.I. Pigment Violet 31; (iv) benzimidazole pigments such as C.I. Pigment Orange 64; (v) quinacridone pigments such as C.I. Pigment Orange 48 and 49, C.I. Pigment Red 122, 202 and 206 and C.I. Pigment Violet 19; (vi) quinophthalone pigments such as C.I. Pigment Yellow 138; (vii) diketopyrrolopyrrole pigments such as C.I. Pigment Orange 71 and 73 and C.I. Pigment Red, 254, 255, 264 and 270; (viii) dioxazine pigments such as C.I. Pigment Violet 23 and 37; (ix) indanthrone pigments such as C.I. Pigment Blue 60; (x) isoindoline pigments such as C.I. Pigment Yellow 139 and 185; (xi) isoindolinone pigments such as C.I. Pigment Orange 61 and C.I. Pigment Yellow 109 and 110; (xii) metal complex pigments such as C.I. Pigment Yellow 153; (xiii) perinone pigments such as C.I. Pigment Orange 43; (xiv) perylene pigments such as C.I. Pigment Black 32, C.I. Pigment Red 149, 178 and 179 and C.I. Pigment Violet 29; (xv) phthalocyanine pigments such as C.I. Pigment Violet 29, C.I. Pigment Blue 15, 15:1, 15:2, 15:3, 15:4, 15:6 and 16 and C.I. Pigment Green 7 and 36; (xvi) aniline black such as C.I. Pigment Black 1; (xvii) azomethine pigments; and (xviii) mixtures thereof.

Suitable effect pigments are selected from the group consisting of (i) plate-like metallic effect pigments such as plate-like aluminum pigments, gold bronzes, fire-colored bronzes, iron oxide-aluminum pigments; (ii) pearlescent pigments, such as metal oxide mica pigments; (iii) plate-like graphite pigments; (iv) plate-like iron oxide pigments; (v) multi-layer effect pigments from PVD films; (vi) liquid crystal polymer pigments; and (vii) mixtures thereof.

Suitable fillers are selected from (i) carbonates such as calcium carbonate or barium carbonate; (ii) sulfates such as calcium sulfate and barium sulfate, (iii) silicates and sheet silicates such as talc, pyrophyllite, mica, kaolin, precipitated calcium silicates, aluminum silicates, calcium/aluminum silicates, sodium/aluminum silicates and mullite; (iv) silicas such as quartz, cristobalite, precipitated silicas and fumed silicas; (v) metal oxides and hydroxides such as aluminum hydroxide and magnesium hydroxide; and (vi) mixtures thereof.

The least one color and/or effect pigment and/or filler is preferably present in a total amount of 0.1 to 50 wt.-%, preferably 5 to 30 wt.-%, based on the total weight of the coating composition. However, it is likewise preferred if the inventive coating composition is free of coloring and/or effect pigments and/or fillers, i.e. said compounds are present in the inventive coating composition in a total amount of 0 wt.-%.

The coating compositions of the invention may further comprise at least one customary and known coatings additive in typical amounts, i.e., in amounts preferably from 0 to 20 wt.-%, more preferably from 0.005 to 15 wt.-% and particularly from 0.01 to 10 wt.-%, based in each case on the total weight of the coating composition. The before-mentioned weight-percentage ranges apply for the sum of all additives likewise.

Suitable additives are selected from the group consisting of (i) UV absorbers; (ii) light stabilizers such as HALS compounds, benzotriazoles or oxalanilides; (iii) rheology modifiers such as sagging control agents (urea crystal modified resins), organic thickeners and inorganic thickeners; (iv) free-radical scavengers; (v) slip additives; (vi) polymerization inhibitors; (vii) defoamers; (viii) wetting agents; (ix) fluorine compounds; (x) adhesion promoters; (xi) leveling agents; (xii) film-forming auxiliaries such as cellulose derivatives; (xiii) fillers, such as nanoparticles based on silica, alumina or zirconium oxide; (xiv) flame retardants; and (xv) mixtures thereof.

Particularly preferred additives are leveling agents, for example polyether modified polymethylalkylsiloxanes.

Properties of the inventive coating composition:

The coating composition according to the invention may be a solvent-based composition or an aqueous composition, preferably a solvent-based composition. In the case of a solvent-based composition, organic solvents are included as a principal constituent, i.e. in amounts of more than 20 wt.-%, more preferably at least 30 wt.-%, based on the total weight of the coating composition. Organic solvents constitute volatile components of the composition and undergo complete or partial vaporization on drying or flashing, respectively. Suitable organic solvents are, for example, ketones such as acetone, methyl ethyl ketone, cyclohexanone, methyl isobutyl ketone, methyl isoamyl ketone or diisobutyl ketone; esters such as ethyl acetate, n-butyl acetate, ethylene glycol diacetate, butyrolactone, diethyl carbonate, propylene carbonate, ethylene carbonate, 2-methoxypropyl acetate (MPA), and ethyl ethoxypropionate; am ides such as N, N-dimethylformam ide, N, N-dimethylacetamide, N-methylpyrrolidone, and N-ethylpyrrolidone; methylal, butylal, 1,3-dioxolane, glycerol formal. Especially preferred organic solvents are n-butyl acetate and acetone.

Such solvent-based compositions preferably comprise water in a total amount of 0 to wt. %, preferably 0 to 10 wt. %, more preferably 0 to 5 wt. %, and very preferably 0 wt. %, based in each case on the total weight of the coating composition.

The at least one solvent, preferably organic solvent, is preferably present in a total amount of 10 to 60% by weight, preferably 20 to 50% by weight, very preferably 30 to 40% by weight, based in each case on the total weight of the coating composition.

The inventive coating composition can be formulated as a one-component or a two-component coating composition, preferably a one-component coating composition. In a one-component composition, all ingredients are already present within a single component and thus, no mixing is required prior to application of the coating composition. Said form is usually chosen if the binder and optionally crosslinker present do not react at storage temperature but only upon subjecting the coating composition to an external stimulus, like heat or irradiation.

The inventive coating composition is preferably a primer composition, a primer-surfacer composition, a basecoat composition or a clearcoat composition, very preferably a primer composition. A primer composition according to the present invention is generally used to provide the first coating layer on a substrate or on an already cured multilayer coating to increase the adhesion between the substrate or multilayer coating and further coating layers applied on said primer. A primer-surfacer composition denotes a coating composition which improves the adhesion to the substrate and at the same time levels out unevenness of the substrate.

The coating composition preferably has a solids content of 20 to 80%, more preferably 30 to 70%, very preferably 45 to 55%, based in each case on the total weight of the coating composition.

Inventive method:

The present invention is also directed to a method of coating a substrate with the inventive coating compositions in which the inventive coating compositions are applied on the substrate, a coating film is formed form the inventive coating composition and said coating film is afterwards cured. On this cured coating layer, it is possible to apply and cure at least one further pigmented or unpigmented coating composition.

According to a first alternative, the substrate is preferably selected from metallic substrates, metallic substrates coated with a cured electrocoat and/or a cured filler, plastic substrates and substrates comprising metallic and plastic components, especially preferably from metallic substrates. In case of metallic and plastic substrates or substrates comprising metallic and plastic components, said substrates may be pretreated before step (1) of the inventive process in any conventional way—that is, for example, cleaned (for example mechanically and/or chemically) and/or provided with known conversion coatings (for example by phosphating and/or chromating) or surface activating pre-treatments (for example by flame treatment, plasma treatment and corona discharge coming).

In this respect, preferred metallic substrates are selected from iron, aluminum, copper, zinc, magnesium and alloys thereof as well as steel. Preferred substrates are those of iron and steel, examples being typical iron and steel substrates as used in the automobile industry sector. The substrates themselves may be of whatever shape—that is, they may be, for example, simple metal panels or else complex components such as, in particular, automobile bodies and parts thereof.

Preferred plastic substrates are basically substrates comprising or consisting of (i) polar plastics, such as polycarbonate, polyamide, polystyrene, styrene copolymers, polyesters, polyphenylene oxides and blends of these plastics, (ii) synthetic resins such as polyurethane RIM, SMC, BMC, ABS and (iii) polyolefin substrates of the polyethylene and polypropylene type with a high rubber content, such as PP-EPDM, and surface-activated polyolefin substrates. The plastics may furthermore be fiber-reinforced, in particular using carbon fibers and/or metal fibers.

As substrates it is also possible, moreover, to use those which contain both metallic and plastics fractions. Substrates of this kind are, for example, vehicle bodies containing plastics parts.

Metallic substrates comprising a cured electrocoating can be obtained by electrophoretically applying an electrocoat material on the metallic substrate and curing said applied material at a temperature of 100 to 250° C., preferably 140 to 220° C. for a period of 5 to 60 minutes, preferably 10 to 45 minutes. Before curing, said material can be flashed off, for example, at 15 to 35° C. for a period of, for example, 0.5 to 30 minutes and/or intermediately dried at a temperature of preferably 40 to 90° C. for a period of, for example, 1 to 60 minutes. Suitable electrocoat materials and also their curing are described in WO 2017/088988 A1, and comprise hydroxy-functional polyether amines as binder and blocked polyisocyanates as crosslinking agent. Before application of the electrocoating material, a conversion coating, such as a zinc phosphate coat, can be applied to the metallic substrate. The film thickness of the cured electrocoat is, for example, 10 to 40 micrometers, preferably 15 to 25 micrometers.

According to a second alternative, the substrate in step (1) is a multilayer coating possessing defect sites. This substrate which possesses defect sites is therefore an original finish (i.e. multilayer coating), which is to be repaired or completely recoated. The above-described defect sites in the multilayer coating can be repaired means of the above-described process the invention. For this purpose, the surface to be repaired in the multilayer coating may initially be abraded. The abrading is preferably performed by partially sanding, or sanding off, either the basecoat and the clearcoat layer or all coating layers. Abrading only the basecoat and the clearcoat layer has become established especially in the OEM automotive refinishing segment, where, in contrast to refinishing in a workshop, generally speaking, defects occur only in the basecoat and/or clearcoat region, but do not, in particular, occur in the region of the underlying filler layer. If defects are also encountered in the filler layer, for example scratches which are produced, for example, by mechanical effects and which often extend down to the substrate surface (metallic or plastic substrate), abrading of all coating layers present on the substrate is necessary.

### Step (1):

In step (1) of the inventive method, the inventive coating composition is applied on the substrate. The application of a coating composition to the substrate is understood as follows: the coating composition in question is applied such that the coating film produced from said composition is disposed on the substrate, but need not necessarily be in direct contact with the substrate. For example, between the coating film and the substrate, there may be other coats disposed. Preferably, the coating composition is applied directly to the substrate in step (1), meaning that the coating film produced is in direct contact with the substrate.

The inventive coating compositions may be applied by the methods known to the skilled person for applying liquid coating materials, as for example by dipping, knifecoating, spraying, rolling, or the like. Preference is given to employing spray application methods, such as, for example, compressed air spraying (pneumatic application), airless spraying, high-speed rotation, electrostatic spray application (ESTA), optionally in conjunction with hot spray application such as hot air (hot spraying), for example. With very particular preference the inventive coating composition is applied via pneumatic spray application or electrostatic spray application. The inventive composition is applied such that the cured coating layer preferably has a film thickness of 20 to 125 μm.

### Step (2):

In step (2) of the inventive method, a coating film is formed from the coating composition applied in step (1). The formation of a film from the applied coating composition can be effected, for example, by flashing off and/or drying the applied coating composition.

“Flashing” or “flash off” is understood as passive or active evaporation of solvents from the inventive coating composition, preferably at 15 to 35° C. for a duration of 0.5 to 30 minutes. In contrast, drying is understood as passive or active evaporation of solvents at a higher temperature than used for flashing, for example at 40 to 90° C. for 20 a duration of 1 to 60 minutes. However, neither flash off nor drying does result in a cured coating layer.

### Step (3):

In step (3) of the inventive method, the coating film formed in step (2) is cured. Curing of the film formed after step (2) is preferably effected by means of radiation curing, preferably by means of UV light and/or electron beam curing (EBC), very preferably by means of UV light. The curing of a coating film or composition is understood accordingly to be the conversion of such a film or composition into the service-ready state, in other words into a state in which the substrate furnished with the coating film in question can be transported, stored, and used in its intended manner. A cured coating film, then, is in particular no longer soft, but instead is conditioned as a solid coating film which, even on further exposure to curing conditions as described later on below, no longer exhibits any substantial change in its properties such as hardness or adhesion to the substrate.

Examples of suitable radiation sources for the radiation curing are low-pressure, medium-pressure, and high-pressure mercury emitters and also fluorescent tubes, pulsed emitters, metal halide emitters (halogen lamps), lasers, LEDs, and also electronic flash installations, enabling radiation curing without a photoinitiator, or excimer emitters. Radiation curing is accomplished by exposure to high-energy radiation, i.e., UV radiation, or by bombardment with high-energy electrons. It is of course also possible to use two or more radiation sources for the curing—two to four, for example. These sources may also each emit in different wavelength ranges. With particular preference, a high-pressure mercury emitter is used in step (3) of the inventive process.

Electron beam processing is usually effected with an electron accelerator. Individual accelerators are usefully characterized by their energy, power, and type. Low-energy accelerators provide beam energies from about 150 keV to about 2.0 MeV. Medium-energy accelerators provide beam energies from about 2.5 to about 8.0 MeV. High-energy accelerators provide beam energies greater than about 9.0 MeV. Accelerator power is a product of electron energy and beam current. Such powers range from about 5 to about 300 kW. The main types of accelerators are: electrostatic direct-current (DC), electrodynamic DC, radiofrequency (RF) linear accelerators (LINACS), magnetic-induction LINACs, and continuous-wave (CW) machines.

If curing is performed by UV-A radiation, the intensity used for curing in step (3) is preferably 1.0 to 6.0 J/cm².

Curing in step (3) is preferably performed at 15 to 30° C. for a duration of 0.1 to 20 minutes, preferably 2 to 5 minutes.

The statements made above, however, do not rule out that the inventive coating composition can additionally be cured under further curing conditions, for example thermal curing conditions.

Optional step (4):

In optional step (4) of the inventive method, at least one further coating composition is applied onto the cured coating layer obtained after step (3). After application of said at least one further coating composition, a film is formed from said coating composition and said film is afterwards cured.

Suitable further coating compositions are all pigmented basecoat compositions, topcoat compositions, clearcoat compositions or tinted clearcoat compositions known to the person skilled in the art. The aforenamed coating compositions can either be aqueous or solvent-borne one-component or two-component coating compositions.

It is also possible to apply more than one further coating film by repeating step (4). The compositions used if step (4) is repeated can be the same or can differ from each other.

The further coating composition may be applied by the methods known to the skilled person for applying liquid coating materials, as previously described in connection with step (1).

The formation of a film from the applied coating composition can be effected, for example, by flashing off and/or drying the applied coating composition as previously described in connection with step (2).

The curing can in principle be carried out at temperatures of 60 to 200° C., for example, in particular 120 to 160° C., for a duration of 5 to 80 minutes, preferably 20 to 40 minutes. If more than one coating layer is produced in step (4), said layers can either be cured separately or jointly. Joint curing is preferred with respect to the overall energy consumption being lower when using a joint curing step.

The coating layers produced from the inventive coating compositions have a higher flexibility compared to coating layers produced from acrylic resins while maintaining the mechanical strength, i.e. hardness. Due to their high flexibility, said coating layers are especially suitable for coating of flexible plastic parts or parts comprising metallic and plastic components. Since the inventive coating compositions can be cured at ambient temperature, they are especially suitable in the automotive refinish sector.

What has been said about the inventive coating composition applies mutatis mutandis with respect to further preferred embodiments of the inventive method.

### Inventive use:

Finally, the present invention relates to the use of the inventive coating composition for improving the flexibility of coating layers, especially of primer layers or primer-surfacer layers, wherein said improvement is obtained with respect to a coating composition not containing the specific binder B.

What has been said about the inventive coating composition and the inventive method applies mutatis mutandis with respect to further preferred embodiments of the inventive use.

The invention is described in particular by the following embodiments:

Embodiment 1: coating composition comprising:
a) at least one binder B, said binder B being prepared by reacting
   a1) at least one ethylene copolymer comprising—in polymerized form—
      i. 10 to 80 wt. % of ethylene;
      ii. 1 to 80 wt. % of at least one polymerizable compound C1 having at least one epoxide group; and
      iii. 0 to 80 wt. % of at least one further polymerizable compound C2 being different from compound C1; with
   a2) at least one compound C3 having at least one unsaturated group and at least one functional group which is able to react with the at least one epoxide group present in compound C1; and
b) optionally at least one photoinitiator.

Embodiment 2: coating composition according to embodiment 1, wherein the ethylene copolymer is prepared in a continuous high-pressure polymerization process.

Embodiment 3: coating composition according to embodiment 2, wherein the polymerization process is carried out at a pressure in the range from 1,000 to 4,000 bar, preferably from 1,200 to 2,500 bar, very preferably 1,500 to 2,200 bar.

Embodiment 4: coating composition according to embodiment 2 or 3, wherein the reaction temperature is in the range of 150 to 300° C., preferably 170 to 250° C., and in particular 190 to 230° C.

Embodiment 5: coating composition according to any of embodiments 2 to 4, wherein the polymerization process is carried out using a monomer feed comprising ethylene, the at least one polymerizable compound C1 and optionally the at least polymerizable compound C2.

Embodiment 6: coating composition according to embodiment 5, wherein the monomer feed comprises ethylene in a total amount of 30 to 98 wt. %, preferably 40 to 95 wt. %, and in particular 50 to 70 wt. % or from 70 to 85 wt., based in each case on the total weight of the monomer feed.

Embodiment 7: coating composition according to embodiment 5 or 6, wherein the monomer feed comprises the at least one polymerizable compound C1 comprising at least one epoxy group in a total amount of 1 to 45 wt. %, preferably 3 to 35 wt. %, based in each case on the total weight of the monomer feed.

Embodiment 8: coating composition according to any of embodiments 5 to 7, wherein the monomer feed comprises the at least one polymerizable compound C2 in a total amount of 0 to 10% wt, preferably 0 to 20% wt, more preferably 0 to 30% wt, very preferably 0 to 40% wt, based in each case on the total weight of the monomer feed.

Embodiment 9: coating composition according to any of embodiments 2 to 8, wherein the polymerization process is carried out in the presence of at least one chain transfer agent, preferably selected from saturated or unsaturated hydrocarbons, aliphatic ketones, aliphatic aldehydes, hydrogen or mixtures thereof, more preferably aliphatic aldehydes and/or aliphatic ketones, very preferably propionaldehyde and/or methyl ethyl ketone and/or hydrogen.

Embodiment 10: coating composition according to embodiment 9, wherein the chain transfer agent is a mixture of propionaldehyde and methyl ethyl ketone in a weight ratio of 4:1 to 1:4, preferably from 3.5:1 to 1:3.0, in particular from 2.8:1 to 1:2.5.

Embodiment 11: coating composition according to embodiment 9 or 10, wherein the at least one chain transfer agent is present in a total amount of least 2 wt. %, preferably 4 to 28 wt. %, more preferably 6 to 23 wt. %, very preferably 9 to 13 wt. % or 13 to 20 wt. %, based on the total weight of the monomer feed and the chain transfer agent.

Embodiment 12: coating composition according to any of embodiments 2 to 11, wherein the polymerization process is carried out in the presence of at least one initiator, preferably selected from di-tert-butyl peroxide, tert-amyl peroxypivalate, tert-butyl peroxypivalat, tert-butyl peroxyisononanoate, tert-butyl peroxy-2-ethylhexanoate, 2,2-di(tert-butylperoxy)butane and mixtures thereof, very preferably from tert-amyl peroxypivalate.

Embodiment 13: coating composition according to embodiment 12, wherein the initiator is present in a total amount of .0.001 to 0.1 wt. %, preferably 0.01 to 0.05 wt. % based in each case on the total weight of the monomer feed.

Embodiment 14: coating composition according to any of embodiments 2 to 13, wherein the polymerization process is followed by a hydrogenation.

Embodiment 15: coating composition according to any of the preceding embodiments, wherein the ethylene copolymer a1) has a weight per epoxy—based on the solids of the ethylene copolymer—of 50 to 500 g/mol, preferably 100 to 400 g/mol, more preferably 150 to 350 g/mol, very preferably 250 to 300 g/mol, as determined by titration with in-situ generated hydrogen bromide (HBr) according to ASTM D1652-11 (2019).

Embodiment 16: coating composition according to any of the preceding embodiments, wherein the ethylene copolymer a1) has a pour point below 25° C., preferably below 20° C., more preferably below 15° C., as determined according to ASTM D 97-05.

Embodiment 17: coating composition according to any of the preceding embodiments, wherein the ethylene copolymer a1) has a weight-average molecular weight M_{w} from 1,000 to 30,000 g/mol, more preferably from 1,500 to 20,000 g/mol, very preferably 3,000 to 12,000 g/mol, as determined by gel-permeation chromatography using polystyrene standards.

Embodiment 18: coating composition according to any of the preceding embodiments, wherein the ethylene copolymer a1) has a polydispersity PD (M_{w}/Mₙ) of 1.3 to 5, preferably 1.5 to 3, more preferably 1.8 to 2.6.

Embodiment 19: coating composition according to any of the preceding embodiments, wherein the ethylene copolymer a1) has a kinematic viscosity at 120° C. (V120) of 10 to 5,000 mm²/s (cst), preferably 40 to 1,500 mm²/g (cst), very preferably 80 to 500 mm²/g, as determined according to ASTM D 445-2018.

Embodiment 20: coating composition according to any of the preceding embodiments, wherein the ethylene copolymer a1) comprises—in polymerized form—from 20 to 80 wt. %, preferably from 25 to 75 wt. %, very preferably from 30 to 70 wt. % of from 30 to wt. %, of ethylene, as determined by ¹H-NMR.

Embodiment 21: Coating composition according to any of the preceding embodiments, wherein the at least one polymerizable compound C1 comprising at least one epoxide group is selected from glycidyl acrylate and/or glycidyl methacrylate.

Embodiment 22: coating composition according to any of the preceding embodiments, wherein the ethylene copolymer a1) comprises—in polymerized form—from 11 to wt. %, preferably from 13 to 65 wt. %, very preferably from 15 to 60 wt. %, of at least one polymerizable compound C1 comprising at least one epoxide group, preferably glycidyl acrylate and/or glycidyl methacrylate, as determined by ¹H-NMR.

Embodiment 23: coating composition according to any of the preceding embodiments, wherein the at least one polymerizable compound C2 is selected from alkyl (meth)acrylates, hydroxyl group-containing (meth)acrylates and mixtures thereof.

Embodiment 24: coating composition according to embodiment 23, wherein the alkyl (meth)acrylates are selected from C₁-C₂₂ alkyl (meth)acrylates, more preferably C₁-C₁₂ alkyl (meth)acrylates such as C₃ alkyl (meth)acrylates, C₄ alkyl (meth)acrylates, C₅ alkyl (meth)acrylates, C₆ alkyl (meth)acrylates, C₇ alkyl (meth)acrylates and C₈ alkyl (meth)acrylates, very preferably methyl (meth)acrylate and/or n-butyl (meth)acrylate and/or 2-ethylhexyl (meth)acrylate.

Embodiment 25: coating composition according to embodiment 23 or 24, wherein the hydroxyl group-containing (meth)acrylates are selected from hydroxy C₁-C₁₂ alkyl group-containing (meth)acrylates, more preferably selected from 2-hydroxyethyl (meth)acrylate, 2-hydroxyisopropyl (meth)acrylate, 3-hydroxypropyl (meth)acrylate and 4-hydroxybutyl (meth)acrylate, preferably 2-hydroxyethyl (meth)acrylate.

Embodiment 26: coating composition according to any of the preceding embodiments, wherein the ethylene copolymer a1) comprises—in polymerized form—from 5 to 70 wt. %, preferably from 10 to 65 wt. %, very preferably from 15 to 60 wt. %, of at least one polymerizable compound C2, preferably methyl (meth)acrylate and/or n-butyl 15 (meth)acrylate and/or 2-ethylhexyl (meth)acrylate and/or 2-hyroxyethyl (meth)acrylate, as determined by ¹H-NMR.

Embodiment 27: coating composition according to any of the preceding embodiments, wherein the functional group of the at least one compound C3 is selected from hydroxy groups, carboxylic acid groups, primary amino groups, secondary amino groups and mixtures thereof, preferably carboxylic acid groups.

Embodiment 28: coating composition according to any of the preceding embodiments, wherein the unsaturated group of the at least one compound C3 is selected from acryloyl and/or allyl groups, preferably acryloyl groups.

Embodiment 29: coating composition according to any of the preceding embodiments, wherein the at least one compound C3 is selected from acrylic acid and/or methacrylic acid and/or allyl mercaptan, preferably acrylic acid.

Embodiment 30: coating composition according to any of the preceding embodiments, wherein the at least one compound C3 is reacted with the ethylene copolymer a1) in a total amount of 1 to 50 wt. % by weight, more preferably 5 to 30 wt. % by weight, even more preferably 10 to 25 wt. % by weight, based on the total solid of binder B.

Embodiment 31: coating composition according to any of the preceding embodiments, wherein the at least one compound C3 is reacted with the ethylene copolymer a1) in butyl acetate.

Embodiment 32: coating composition according to any of the preceding embodiments, wherein the at least one compound C3 is reacted with the ethylene copolymer a1) in the presence of a catalyst preferably selected from amine compounds, phosphorous compounds, metal salts and mixtures thereof, more preferably tertiary amines having at least one C₁₁₋₁₃ alkyl group, very preferably dimethyl dodecyl amine.

Embodiment 33: coating composition according to any of the preceding embodiments, wherein the at least one binder B has a weight-average molecular weight M_{w} from 1,000 to 30,000 g/mol, preferably from 1,500 to 15,000 g/mol, very preferably 3,000 to 5,000 g/mol, as determined by gel-permeation chromatography using polystyrene standards.

Embodiment 34: coating composition according to any of the preceding embodiments, wherein the at least one binder B has an average double-bond functionality of 1 to 15, preferably 2 to 10, very preferably 2.5 to 7, as determined by titration with in-situ generated hydrogen bromide (HBr) according to ASTM D1652-11 (2019).

Embodiment 35: coating composition according to any of the preceding embodiments, wherein the coating composition comprises the at least one binder B in a total amount of 10 to 60 wt. %, preferably 15 to 50 wt. %, more preferably 25 to 45 wt. %, very preferably 30 to 40 wt. %, based in each case on the total weight of the coating composition.

Embodiment 36: coating composition according to any of the preceding embodiments, wherein the at least one photoinitiator is selected from the group consisting of phosphine oxides, benzophenones, α-hydroxyalkyl aryl ketones, thioxanthones, anthraquinones, acetophenones, benzoins and benzoin ethers, ketals, imidazoles or phenylglyoxylic acids and mixtures thereof. Particularly preferred photoinitiators are diphenyl(2,4,6-trimethylbenzoyl)phosphine oxide, ethyl (2,4,6-trimethylbenzoyl)phenylphosphinate, phenylbis(2,4,6-trimethylbenzoyl)phosphine oxide, benzophenone, 1-benzoylcyclohexan-1-ol, 2-hydroxy-2,2-dimethylacetophenone and 2,2-dimethoxy-2-phenylacetophenone and mixtures thereof, preferably a mixture of ethyl phenyl(2,4,6-trimethylbenzoyl)phosphinate and phenyl bis(2,4,6-trimethylbenzoyl)phosphine oxide.

Embodiment 37: coating composition according to any of the preceding embodiments, wherein the at least one photoinitiator is present in a total amount of 0.5 to 5 wt. %, preferably 1 to 4 wt. %, very preferably 1.5 to 2.5 wt. %, based on the total weight of the coating composition.

Embodiment 38: coating composition according to any of the preceding embodiments, wherein the coating composition further comprises at least one reactive diluent.

Embodiment 39: coating composition according to embodiment 37, wherein the reactive diluent is selected from the group consisting of alkyl (meth)acrylates, preferably C₁-C₁₂ alkyl (meth)acrylates, very preferably iso-bornyl acrylate.

Embodiment 40: coating composition according to embodiment 37 or 38, wherein the reactive diluent is present in a total amount of up to 40 wt. %, very preferably 5 to 25 wt. % based on the total weight of the coating composition.

Embodiment 41: coating composition according to any of the preceding embodiments, wherein the coating composition further comprises at least one further binder B1, said binder being different from binder B.

Embodiment 42: coating composition according to any of the preceding embodiments, wherein the coating composition further comprises at least one additive selected from the group consisting of (i) UV absorbers; (ii) light stabilizers such as HALS compounds, benzotriazoles or oxalanilides; (iii) rheology modifiers such as sagging control agents (urea crystal modified resins), organic thickeners and inorganic thickeners; (iv) free-radical scavengers; (v) slip additives; (vi) polymerization inhibitors; (vii) defoamers; (viii) wetting agents; (ix) fluorine compounds; (x) adhesion promoters; (xi) leveling agents; (xii) film-forming auxiliaries such as cellulose derivatives; (xiii) fillers, such as nanoparticles based on silica, alumina or zirconium oxide; (xiv) flame retardants; and (xv) mixtures thereof.

Embodiment 43: coating composition according any of the preceding embodiments, wherein the coating composition is a solvent-based coating composition.

Embodiment 44: coating composition according to any of the preceding embodiments, wherein it is a one-component or a two-component coating composition.

Embodiment 45: coating composition according to any of the preceding embodiments, wherein it is a primer composition, a primer-surfacer composition, a basecoat composition or a clearcoat composition, preferably a primer composition.

Embodiment 46: coating composition according any of the preceding embodiments, wherein the coating composition has a solids content of 20 to 80%, preferably 30 to 70%, very preferably 45 to 55%, based in each case on the total weight of the coating composition.

Embodiment 47: method for producing at least one coating on a substrate, comprising:
(1) applying at least one coating composition as claimed in any of embodiments 1 to 46 to the substrate;
(2) forming a coating film from the composition applied in step (1);
(3) curing the coating film obtained after step (2); and
(4) optionally applying at least one further pigmented or unpigmented coating composition being different from the coating composition applied in step (1) to the cured coating film obtained after step (3), forming a film from said at least one further coating composition and curing said at least one further coating composition.

Embodiment 48: method according to embodiment 47, wherein the substrate is selected from metallic substrates, metallic substrates coated with a cured electrocoat and/or a cured filler, plastic substrates and substrates comprising metallic and plastic components, preferably from metallic substrates.

Embodiment 49: method according to embodiment 48, wherein the metallic substrate is selected from the group comprising or consisting of iron, aluminum, copper, zinc, magnesium and alloys thereof as well as steel.

Embodiment 50: method according embodiment 47, characterized in that the substrate in step (1) is a multilayer coating possessing defect sites.

Embodiment 51: coating obtained by a method as claimed in any of embodiments 47 to 50.

Embodiment 52: coating according to embodiment 51, wherein the coating obtained after step (3) has a Koenig hardness of 10 to 50 seconds, preferably 12 to 40 seconds, as determined according to ASTM D4366-16 method A.

Embodiment 53: coating according to embodiment 51 or 52, wherein the coating obtained after step (3) has an elongation at break of at least 8%, preferably 8.2 to 100%, more preferably 8.2 to 50%, as determined by a stress-strain curve measured by ASTM D638-14 (2014) under a strain rate of 3% per min at 23° C.

Embodiment 54: use of a coating composition as claimed in any of embodiments 1 to 46 for improving the flexibility of coating layers, especially of primer layers or primer-surfacer layers.

### EXAMPLES

The present invention will now be explained in greater detail through the use of working examples, but the present invention is in no way limited to these working examples. Moreover, the terms “parts”, “%” and “ratio” in the examples denote “parts by mass”, “mass %” and “mass ratio” respectively unless otherwise indicated.

### 1. Methods of Determination

1.1 Number-average molecular weight (Mₙ), weight-average molecular weight (M_{w}), and polydispersity Index (PDI)

The number-average molecular weight distribution (Mₙ) and the weight-average molecular weight distribution (M_{w}) were, unless otherwise indicated, determined via GPC. The polydispersity (PDI) was calculated as PDI=(M_{w}/Mₙ). The GPC analysis was made with a RI detector, a column temperature of 35° C. and THF with 0,1% trifluoro acetic acid as elution medium. The calibration was done with very narrow distributed polystyrene standards from the Polymer Laboratories with a molecular weight M_{w}=from 580 until 6,870 g/mol.

1.2 Amount of ethylene and compounds C1 and C2 present in polymerized form in the ethylene copolymer

The amount of ethylene as well as polymerizable compounds C1 and C2 present in polymerized form in the ethylene copolymer is determined by ¹H-NMR, a method know to the skilled person.

### 1.3 Kinematic Viscosity

The kinematic viscosity at 120° C. (V120) was determined according to ASTM D 445-2018.

1.4 Appearance of the ethylene copolymer

The appearance of the ethylene copolymers was determined visually.

### 1.5 Pour Point (PP)

The Pour Point PP was determined according to ASTM D 97-05.

1.6 Solid content (solids, non-volatile fraction)

Unless otherwise indicated, the solids content, also referred to as solid fraction or non-volatile fraction hereinafter, was determined in accordance with DIN EN ISO 3251-2008-06 at 130° C.; 60 min, initial mass 1.0 g.

1.8 Glass transition temperature (T 2) of ethylene copolymers

The glass transition temperature (T_{g}) of the polymers was determined with TA Instruments Q2000 DSC. The samples were run from −90 to 180° C. at 15° C./min twice, with a 30-minute isothermal hold at 180° C. after the first heat. T_{g} was measured on the second heat.

1.9 Cloud point (CP)

The cloud point was determined according to DIN EN ISO 3015:2018-04.

1.10 Determination of weight per epoxy

The weight per epoxy—based on the solids—was determined by titration with in-situ generated hydrogen bromide (HBr) according to ASTM D1652-11 (2019).

1.11 Determination of acryloyl functionality

The average acryloyl functionality was obtained by determination of the epoxy functionality consumed by the reaction of the epoxy function of the ethylene copolymer a1) with the compound C3). The epoxy functionality of the ethylene copolymer a1) and the polymer obtained after reaction of the ethylene copolymer a1) with compound C3) was each obtained by titration with in-situ generated hydrogen bromide (HBr) according to ASTM D1652-11 (2019) .

1.12 Determination of non-volatile content (NV)

The non-volatile content was calculated based on the actual solids of the individual ingredients.

2. Synthesis of different binders

Abbreviations of components
E: ethylene
GMA: glycidyl methacrylate
EHA: 2-ethylhexyl acrylate
PA: propionaldehyde
BuAc: butyl acetate
MIBK: methyl isobutyl ketone
iBOA: iso-bornyl acrylate
   2.1 Synthesis of inventive unsaturated ethylene copolymers B-I1 to B-I3
   2.1.1 Synthesis of ethylene copolymer a1)

A high-pressure autoclave, of the type described in the literature (M. Buback et al., Chem. Ing. 25 Tech. 1994, 66, 510-513) was used for continuous copolymerization.

Ethylene was fed continuously into a first compressor until approximately 250 bar. Separately from this, the respective amount of GMA was also compressed continuously to an intermediate pressure of 250 bar and was mixed with the ethylene feed (see Table 1 for amounts of ethylene and GMA). The ethylene/GMA mixture was further compressed using a second compressor. The reaction mixture is feed to a 1-liter autoclave having the pressure and temperature listed in Table 1. The desired temperature is maintained by dosing the appropriate amount of the initiator tert-amyl peroxypivalate in isodecane, to the autoclave separately from the monomer feed (about 1,000 to 1,500 ml/h).

Separately from this, the respective amount of chain transfer agent (cf. Table 1 “Regulator Feed”) was first compressed to an intermediate pressure of 250 bar and then compressed with the aid of a further compressor before it was fed continuously into the high-pressure autoclave.

The output of the polymerization reaction listed in Table 1 was usually around 5 to 6 kg/h at a conversion of 30 to 45 wt. % (based on ethylene feed). Details of the reaction conditions are summarized in Table 1. The analytical data of the prepared ethylene copolymer a1) is summarized in Table 2.

TABLE 1
Reaction conditions

| | | | Ethylene | Acrylate | Regulator |
|---|---|---|---|---|---|
| | P | T | feed | feed | feed |
| Reactants | [bar] | [° C.] | [g/h] | [g/h] | [g/h] |
| E, GMA | 1,700 | 220 | 11,980 | GMA: 3,180 | PA: 2,000 |
| | | | | | (11.6 wt. %) |

TABLE 2
Analytical data of obtained ethylene copolymers a1)

| | | Ethylene |
|---|---|---|
| | | copolymer a1) |
| Monomer | Ethylene | 46.0 |
| composition (wt. %) | Glycidyl methacrylate | 54.0 |
| | Total | 100 |

| | |
|---|---|
| Number-average molecular weight (Mₙ) [g/mol] | 1,930 |
| Weight-average molecular weight (M_{w}) [g/mol] | 3,850 |
| Polydispersity (PD) | 2.0 |
| Kinematic viscosity at 120° C. (V120) [mm²/s] | 100 |
| Glass transition temperature (T_{g}) | −45.1 and −24.8 |
| Weight per epoxy equivalent [g/mol] | 273.33 |
| Non-volatile content [%] | 100 |

2.1.2 Reaction of ethylene copolymer a1) with compound C3 (acrylic acid)

The unsaturated ethylene copolymer a1) prepared according to point 2.1.1 was reacted with acrylic acid under aerated conditions using dimethyl dodecyl amine as catalyst and 1000 ppm of 4-t-butyl catechol as inhibitor with respect to total solid at a temperature of 110° C. for 2.5-6 h or until the desired WPE is achieved. The amounts of ethylene copolymer a1) and acrylic acid (in weight %, based on the total weight of ethylene copolymer and acrylic acid) as well as the solvent used for the reaction are listed in Table 3. The analytical data of the prepared unsaturated ethylene copolymers B-I1 to B-I3 are summarized in Table 4.

TABLE 3
Amounts of ethylene copolymer a1), acrylic acid and solvents

| | B-I1 | B-I2 | B-I3 |
|---|---|---|---|
| Amount ethylene copolymer [wt. %] | 80 | 87 | 87 |
| Amount of acrylic acid [wt. %] | 20 | 13 | 13 |
| solvent | BuAc | BuAc | BuAc + iBOA |
| | | | (1:1 w/w) |

TABLE 4
Analytical data of obtained unsaturated
ethylene copolymers B-I1 to B-I3

| | B-I1 | B-I2 | B-I3 |
|---|---|---|---|
| Number-average molecular | 2,868 | 2,480 | 2,436 |
| weight (Mₙ) [g/mol] | | | |
| Weight-average molecular | 4,510 | 4,176 | 4,429 |
| weight (M_{w}) [g/mol] | | | |
| Polydispersity (PD) | 1.6 | 1.7 | 1.8 |
| Average acryloyl functionality | 6.0 | 3.4 | 3.5 |
| Weight per acryloyl [g/mol] | 478 | 729 | 696 |
| Weight per epoxy [g/mol] | 2218 | 690 | 693 |
| Non-volatile content | 76.76 | 91.95 | 91.0 |

2.2 Synthesis of comparative acrylic copolymer B-C1 and B-C2
2.2.1 Synthesis of epoxy group containing acrylic copolymer AC-1

To a 3 L 4-necked round bottom flask equipped with condenser and inert gas (nitrogen) line, was added 182.5 g of methyl isobutyl ketone and heated to 110° C. To this, total 1661.2 g of monomer mixture listed in Table 5 and 75% of the total amount of initiator feed (see Table 5) was fed in 3 hours at a continuous rate through a monomer addition pump. After monomer addition was complete, the remaining 25% of initiator feed was added in another 1 hour by continuous addition through an addition funnel. At the completion of addition of monomer and initiator, the addition lines were rinsed with 26.1 g of methyl isobutyl ketone. Further, the reaction temperature was held at 110° C. for 1 hour, followed by increasing temperature to 120° C. in 30 min and holding for another 30 min.

TABLE 5
Reagents for the synthesis of acrylic copolymer AC-1

| | | Amount | Amount |
|---|---|---|---|
| | | [wt.-%] | [g] |
| Initiator | Azobis(2-methylbutanenitrile) | 2.61 | 52.1 |
| feed | Methyl isobutyl ketone | 2.61 | 52.1 |
| Monomer | Styrene | 0.78 | 15.6 |
| mixture | Methyl methacrylate | 0.78 | 15.6 |
| | Glycidyl methacrylate | 29.97 | 599.4 |
| | 2-Ethylhexyl acrylate | 46.32 | 926.4 |
| | Methyl isobutyl ketone | 5.21 | 104.3 |

The analytical data of the epoxy group containing acrylic copolymer AC1 is summarized in Table 6.

TABLE 6
Analytical data of obtained epoxy group
containing acrylic copolymer AC-1

| | | Acrylic |
|---|---|---|
| | | copolymer AC-1 |
| composition | 2-ethylhexyl acrylate | 59.5 |
| Monomer | Methyl methacrylate | 1.0 |
| (wt. %) | Styrene | 1.0 |
| | Glycidyl methacrylate | 38.5 |
| | Total | 100 |

| | |
|---|---|
| Number-average molecular weight (Mₙ) [g/mol] | 8,167 |
| Weight-average molecular weight (M_{w}) [g/mol] | 18,234 |
| Polydispersity (PD) | 2.2 |
| Glass transition temperature (T_{g}) | −27.1 |
| Weight per epoxy equivalent [g/mol] | 381.00 |
| Nonvolatile content [%] | 79.24 |

2.2.2 Reaction of epoxy group containing acrylic copolymer AC-1 with compound C3 (acrylic acid)

The epoxy group containing acrylic copolymer AC-1 prepared according to point 2.2.1 was reacted with acrylic acid under aerated conditions using dimethyl dodecyl amine as catalyst and 1000 ppm of 4-t-butyl catechol as inhibitor with respect to total solid at a temperature of 110° C. for 3 h or until the desired WPE is achieved. The amounts of acrylic copolymer AC-1 and acrylic acid (in weight %, based on the total weight of ethylene copolymer and acrylic acid) as well as the solvent used for the reaction are listed in Table 7. The analytical data of the prepared unsaturated acrylic copolymers B-C1 and B-C2 are summarized in Table 8.

TABLE 7
Amounts of epoxy group containing acrylic
copolymer AC-1, acrylic acid and solvents

| | B-C1 | B-C2 |
|---|---|---|
| Amount acrylic copolymer | 85 | 85 |
| AC-1 [wt. %] | | |
| Amount of acrylic acid [wt. %] | 15 | 15 |
| solvent | MIBK:BuAc | MIBK:BuAc:iBOA |
| | (1:2, w/w) | (6:7:7, w/w/w) |

TABLE 8
Analytical data of obtained unsaturated
acrylic copolymers B-C1 and B-C2

| | B-C1 | B-C2 |
|---|---|---|
| Number-average molecular weight (Mₙ) [g/mol] | 8,459 | 8,459 |
| Weight-average molecular weight (M_{w}) [g/mol] | 18,485 | 18,485 |
| Polydispersity (PD) | 2.2 | 2.2 |
| Average acryloyl functionality | 16.8 | 16.8 |
| Weight per acryloyl [g/mol] | 504 | 504 |
| Weight per epoxy [g/mol] | 1827 | 1827 |
| Non-volatile content | 78.57 | 80.26 |

3. Preparation of coating compositions

The primer compositions listed in Table 9 were prepared by mixing the ingredients listed in this table until a homogenous mixture is obtained. The comparative examples P-C1 and P-C2 contain approximately the same weight per acryloyl functionality compared to inventive example P-11.

TABLE 9
Primer formulations (amounts in wt. %)

| | inventive | | | comparative | |
|---|---|---|---|---|---|
| | P-I1 | P-I2 | P-I3 | P-C1 | P-C2 |
| Unsaturated ethylene copolymer B-I1 | 30.92 | — | — | — | — |
| Unsaturated ethylene copolymer B-I2 | — | 28.85 | — | — | — |
| Unsaturated ethylene copolymer B-I3 | — | — | 28.86 | — | — |
| Unsaturated acrylic copolymer B-C1 | — | — | — | 30.64 | — |
| Unsaturated acrylic copolymer B-C2 | — | — | — | — | 30.39 |
| Omnirad 2100 ¹⁾ | 1.90 | 2.10 | 1.93 | 1.95 | 2.10 |
| Acetone | 17.09 | 18.94 | 17.33 | 17.56 | 18.94 |
| BYK-325 (80% in Oxsol 100) ²⁾ | 0.10 | 0.10 | 0.10 | 0.10 | 0.10 |
| Total | 50 | 50 | 50 | 50 | 50 |
| Theoretical non-volatile content [%] | 51.35 | 56.92 | 52.08 | 52.77 | 56.91 |

¹⁾ photoinitiator, blend of ethyl phenyl(2,4,6-trimethylbenzoyl)phosphinate and phenyl bis(2,4,6-trimethylbenzoyl)-phosphine oxide (IGM Resins)
²⁾ silicone-containing surface additive (supplied by BYK Chemie) in Oxol 100 (parachlorobenzotrifluoride)

4. Preparation of coated substrates and evaluation of cured primer layer
4.1 Preparation of cured coating layers on plastic substrate

Cured coating layers are obtained from the coating compositions P-I1 to P-I3 (inventive) and P-C1 to P-C2 (comparative) as follows:

Thermoplastic olefin (TPO) substrates were washed with soap and water, scuffed with a gray scuff pad, cleaned with R-M 903 Anti-Static Final Wipe (supplied by BASF Corporation) and tacked-off with a tack rag. The cleaned and bare cold-rolled steel (CRS) was tacked-off with a tack rag.

Application of the prepared primer coatings to these substrates was made with a #70 Mayer rod. The applied coatings were flashed for 15 minutes at 22° C. prior to curing. Curing was done with a high-pressure mercury “D” bulb in a 900-watt unit fitted with a UVB/UVC filter. The curing was done ten inches from the lamp for 4 minutes. The resulting dry film thickness was 52 to 58 μm

4.2 Evaluation of cured primer layer
4.2.1 Koenig hardness

The Koenig hardness was determined according to ASTM D4366-16 method A.

4.2.2 Bend flexibility

The bend flexibility was measured using TPO substrates according to ASTM D522-17 method B.

4.2.3 Surface tackiness

Surface tackiness was evaluated by touch. The coatings were rated by the relative degree of tacky feeling among the coatings in the experiment (1 =the least tackiness (best surface cure), 3 =the most tackiness (worst surface cure)).

4.2.4 Elongation at break

Elongation at break for all samples were obtained from Stress-strain curve measured by ASTM D638-14 (2014) using a DMA (TA Instruments DMA 850) under a strain rate of 3% per min at 23° C. Elongation at break is the ratio between increased length and the initial length after breakage of the tested specimen. 3 replicates were tested for each sample.

4.2.5 Glass transition temperature (T_{g}) and crosslink density

The glass transition temperature (T_{g}) and crosslink density of the cured primer coatings was determined using DMTA (dynamic mechanical thermo analysis). The T_{g} of the cured primer film is corresponding to the temperature of the highest tan δ, which is measured at a frequency of 1 Hz, amplitude of 0.2%, a temperature increase of 3° C. per minute from −30 to 0° C. and a temperature increase of 2° C. per minute from 0 to 200° C. The crosslinking density (# of crosslinks/volume) was calculated via the storage modulus (E′) using the equation E′/3RT=2(# of crosslinks/volume). The E′ is the minimum at rubbery plateau in DMA curve obtained by ASTM D412-16 (2016).

### 4.3 Results

The results obtained for the primer layers produced according to point 4.1 are shown in Table 10.

TABLE 10
Physical properties of primer layers obtained from
primer compositions P-I1 to P-I3 and P-C1 to P-C2

| | | inventive | | | comparative | |
|---|---|---|---|---|---|---|
| | | P-I1 | P-I2 | P-I3 | P-C1 | P-C2 |
| Unsaturated ethylene copolymer B-I1 | | 30.92 | — | — | — | — |
| Unsaturated ethylene copolymer B-I2 | | — | 28.85 | — | — | — |
| Unsaturated ethylene copolymer B-I3 | | — | — | 28.86 | — | — |
| Unsaturated acrylic copolymer B-C1 | | — | — | — | 30.64 | — |
| Unsaturated acrylic copolymer B-C2 | | — | — | — | — | 30.39 |
| Omnirad 2100 ¹⁾ | | 1.90 | 2.10 | 1.93 | 1.95 | 2.10 |
| Acetone | | 17.09 | 18.94 | 17.33 | 17.56 | 18.94 |
| BYK-325 (80% in Oxsol 100) ²⁾ | | 0.10 | 0.10 | 0.10 | 0.10 | 0.10 |
| Koenig | # oscillations: | 38 | 16 | 13 | 44 | 46 |
| hardness | @ mils (dry film thickness): | 2.2 | 2.3 | 2.2 | 2.2 | 2.2 |
| Bend flexibility | 62 mm diameter | 1 crack | No cracks | No cracks | 4 cracks | 10 cracks |
| @ 22 ° C. | 32 mm diameter | NR ³⁾ | No cracks | No cracks | NR ³⁾ | NR ³⁾ |

| | | | | | |
|---|---|---|---|---|---|
| Surface tackiness | 1 | 3 | 3 | 2 | 2 |
| Elongation at break [%] | 8.78 | 18.68 | 32.7 | 6.55 | 8.0 |
| T_{g} of primer layer [° C.] | 70.7 | 34.9 | 35.7 | 81.4 | 84.2 |
| E′ at rubbery plateau (MPa) | 41 | 21 | 16 | 54 | 45 |
| Crosslinking density | 2777 | 1422 | 1084 | 3657 | 3048 |

¹⁾ photoinitiator, blend of ethyl phenyl(2,4,6-trimethylbenzoyl)phosphinate and phenyl bis(2,4,6-trimethylbenzoyl)-phosphine oxide (IGM Resins)
²⁾ silicone-containing surface additive (supplied by BYK Chemie) in Oxol 100 (parachlorobenzotrifluoride)
³⁾ test not run

Discussion of results

Comparison of inventive example P-I1 with comparative example P-C1 demonstrates a significantly improved bend flexibility and higher elongation at break while resulting in less tackiness. At the same time, the hardness is only slightly lower in the case of P-I1 . Without wishing to be bound to this particular theory, it is believed that the improved flexibility and elongation at break without dramatically effecting the hardness is due to the lower glass transition temperature of the polyethylene segment compared to the poly(2-ethylhexyl acrylate) segment and the higher effective chain length of the cured unsaturated ethylene copolymer.

The flexibility of the cured coating layer can be modified by reducing the acryloyl functionality in the unsaturated ethylene copolymer used as binder (see P-I1 vs. P-I2 having a lower acryloyl functionality and therefore higher flexibility). However, the higher flexibility leads to a significantly decreased hardness of the cured coating layer.

When iso-bornyl acetate was used as a diluent (see P-I3 and P-C2), the hardness of the cured coating layer significantly decreased in case of P-I3 as compared to P-I1 while at the same time, the flexibility and elongation at break significantly increased. Surprisingly, the addition of iso-bornyl acrylate to the comparative primer composition P-C2 did not result in a significant influence on the hardness but dramatically reduces the bend flexibility. This indicates that lowering the effective chain length by addition of iso-bornyl acrylate as diluent is more detrimental to the film flexibility when using the unsaturated acrylate copolymer compared to the use of the unsaturated ethylene copolymer.

In conclusion, the unsaturated ethylene copolymer can serve as an excellent binder system to provide a high film flexibility at similar hardness values compared to the use of non-ethylated copolymers (P-I1 vs. P-C1) in UV curable coating compositions. In addition, due to the bio renewable resource ethylene and the better economic viability of the raw material, the unsaturated ethylene copolymers provide a sustainable binder system.

1. A coating composition comprising:
a) at least one binder B, said binder B being prepared by reacting
a1) at least one ethylene copolymer comprising—in polymerized form—
i. 10 to 80 wt. % of ethylene;
ii. 1 to 80 wt. % of at least one polymerizable compound C1 having at least one epoxide group; and
iii. 0 to 80 wt. % of at least one further polymerizable compound C2 being different from compound C1; with
a2) at least one compound C3 having at least one unsaturated group and at least one functional group which is able to react with the at least one epoxide group of compound C1; and
b) optionally at least one photoinitiator.

2. The coating composition according to claim 1, wherein the ethylene copolymer is prepared in a semi-continuous high-pressure polymerization process or a continuous high-pressure polymerization process.

3. The coating composition according to claim 1, wherein the ethylene copolymer a1) has a weight per epoxy—based on the solids of the ethylene copolymer—of 50 to 500 g/mol as determined by titration with in-situ generated hydrogen bromide (HBr) according to ASTM D1652-11 (2019).

4. The coating composition according to claim 1, wherein the ethylene copolymer a1) comprises—in polymerized form—from 20 to 80 wt. % of ethylene, as determined by ¹H-NMR.

5. The coating composition according to claim 1, wherein the at least one polymerizable compound C1 comprising at least one epoxide group is selected from the group consisting of glycidyl acrylate, glycidyl methacrylate, and combinations thereof.

6. The coating composition according to claim 1, wherein the ethylene copolymer a1) comprises—in polymerized form—from 11 to 70 wt. % of at least one polymerizable compound C1 comprising at least one epoxide group as determined by ¹H-NMR.

7. The coating composition according to claim 1, wherein the functional group of the at least one compound C3 is selected from the group consisting of hydroxy groups, carboxylic acid groups, thiol groups, primary amino groups, secondary amino groups and mixtures thereof.

8. The coating composition according to claim 1, wherein the unsaturated group of the at least one compound C3 is selected from the group consisting of acryloyl, and/of allyl groups, and combinations thereof.

9. The coating composition according to claim 1, wherein the at least one compound C3 is selected from the group consisting of acrylic acid, methacrylic acid, allyl mercaptan, and combinations thereof.

10. The coating composition according to claim 1, wherein the at least one compound C3 is reacted with the ethylene copolymer a1) in a total amount of 1 to 50 wt. % by weight, based on the total solids of binder B.

11. The coating composition according to claim 1, wherein the coating composition comprises the at least one binder B in a total amount of 10 to 60 wt. % based on the total weight of the coating composition.

12. The coating composition according to claim 1, wherein the coating composition is a primer composition, a primer-surfacer composition, a basecoat composition or a clearcoat composition.

13. A method for producing at least one coating on a substrate, comprising
(1) applying at least one coating composition as claimed in claim 1 to the substrate;
(2) forming a coating film from the composition applied in step (1);
(3) curing the coating film obtained after step (2); and
(4) optionally applying at least one further pigmented or unpigmented coating composition being different from the coating composition applied in step (1) to the cured coating film obtained after step (3), forming a film from said at least one further coating composition and curing said at least one further coating composition.

14. A coating obtained by a method as claimed in claim 13.

15. A method of using the coating composition as claimed in claim 1, the method comprising using the coating composition for improving the flexibility of coating layers.

16. The coating composition according to claim 1, wherein the ethylene copolymer is prepared in a continuous high-pressure polymerization process.

17. The coating composition according to claim 1, wherein the ethylene copolymer a1) has a weight per epoxy—based on the solids of the ethylene copolymer—of 100 to 400 g/mol as determined by titration with in-situ generated hydrogen bromide (HBr) according to ASTM D1652-11 (2019).

18. The coating composition according to claim 1, wherein the ethylene copolymer a1) comprises—in polymerized form—25 to 75 wt. % of ethylene, as determined by ¹H-NMR.

19. The coating composition according to claim 1, wherein the ethylene copolymer a1) comprises—in polymerized form—from 11 to 70 wt. % of at least one polymerizable compound C1 comprising at least one epoxide group selected from the group consisting of glycidyl acrylate, glycidyl methacrylate, and combinations thereof, as determined by ¹H-NMR.

20. The coating composition according to claim 1, wherein the functional group of the at least one compound C3 is selected from the group consisting of carboxylic acid groups.
